(19) United States
(12) Patent Application Publication
(10) Pub. No.: US 2012/0268512 A1
(43) Pub. Date: Oct. 25, 2012

(54) IMAGE FORMATION APPARATUS

(75) Inventor: Masahiko Tsuyuki, Chino-city (JP)

(73) Assignee: SEIKO EPSON CORPORATION, Tokyo (JP)

(21) Appl. No.: 13/453,102

(22) Filed: Apr. 23, 2012

(30) Foreign Application Priority Data
Apr. 21, 2011 (JP) 2011-094779

(51) Int. Cl. B41J 29/38

(52) U.S. Cl. 347/10

(57) ABSTRACT

An image formation apparatus includes a dot formation element; a voltage signal generation circuit configured to generate a voltage signal by using an amplification circuit including a transistor, the voltage signal including a plurality of driving voltage pulses each thereof driving the dot formation element, and at least one temperature measurement voltage portion each thereof being provided between two successive ones of the driving voltage pulses; a temperature measurement control unit configured to measure a temperature of the transistor on the basis of the voltage signal; and a switch circuit configured to output the voltage signal to the dot formation element during a period when the transistor amplifies a signal corresponding to each of the driving voltage pulses, and output the voltage signal to the temperature measurement control unit during a period when the transistor amplifies a signal corresponding to each of the at least one temperature measurement voltage portion.

The entire disclosure of Japanese Patent Application No. 2011-094779, filed on Apr. 21, 2011 is expressly incorporated herein by reference.

### BACKGROUND

1. Technical Field

The present invention relates to an image formation apparatus having a function of measuring the temperature of a transistor for generating driving voltage pulses applied to a dot formation element thereof.

2. Related Art

Various methods for measuring the junction temperature of a transistor have been well known to those skilled in the art (for example, refer to JP-A-64-16972). Further, it has been well known to those skilled in the art that a transistor can be used as a means for measuring temperature (for example, refer to JP-A-2004-150897 and JP-A-2001-116624).

An overheated condition of a transistor for generating driving voltage pulses that are applied to a dot formation element leads to shape variations of the pulses; thereby causing accuracy of the dot formation to be reduced. Therefore, it is desirable to maintain the temperature of the transistor at a constant desired level by cooling the transistor in the overheated condition by means of a method of rotating a fan, or the like. Further, in order to ensure this maintenance, it is necessary to measure the temperature of the transistor with high accuracy. But, a use of additional parts for the temperature measurement, such as a thermistor, leads to an increase of cost due to an increase of the number of parts.

### SUMMARY

An advantage of some aspects of the invention is to provide an image formation apparatus configured to make it possible to measure the temperature of a transistor for generating driving voltage pulses applied to a dot formation element thereof in a simple configuration.

An image formation apparatus according to an aspect of the invention includes a dot formation element, a voltage signal generation circuit, a temperature measurement control unit and a switch circuit. The dot formation element performs dot formation operations, such as an operation of discharging drops of recording liquid, to form dots on a recording medium. A voltage signal generated by the voltage signal generation circuit includes a plurality of driving voltage pulses and at least one temperature measurement voltage portion. The driving voltage pulses mean signal portions each having electric potential changes which contribute to the dot formation operations performed by the dot formation element. Each of the at least one temperature measurement voltage portion is provided between two successive ones of the driving voltage pulses (that is, each of the at least one temperature measurement voltage portion is provided so as not to be overlapped by any of the driving voltage pulses). The voltage signal generation circuit performs amplification of a signal by using an amplification circuit including a transistor to generate the voltage signal having a waveform which includes the plurality of driving voltage pulses and the at least one temperature measurement voltage portion such as described above. The switch circuit performs switching so that the output destinations of two kinds of signals, i.e., the plurality of voltage signal pulses and the at least one temperature measurement portion, which are included in the voltage signal generated by the voltage signal generation circuit, can be the dot formation element and the temperature measurement control unit, respectively. That is, the switch circuit outputs the voltage signal to the dot formation element during a period when a signal corresponding to each of the driving voltage pulses is amplified by the amplification circuit, and outputs the voltage signal to the temperature measurement control unit during a period when a signal corresponding to each of the at least one temperature measurement voltage portion is amplified by the amplification circuit.

The temperature measurement control unit measures a temperature of the transistor on the basis of the voltage signal generated by the voltage signal generation circuit. For this purpose, the temperature measurement control unit is preliminarily provided with a temperature characteristic of the transistor. That is, the temperature measurement control unit is preliminarily provided with a temperature characteristic of the voltage value of a voltage signal corresponding to an output signal (an electric current) resulting from amplification performed by the transistor on an input signal (an electric current) having been input thereto, the input signal being a signal which enables generation of the at least one temperature measurement voltage portion, and which has a predetermined magnitude. Further, the temperature measurement control unit obtains a voltage value corresponding to each of the at least one temperature measurement voltage portion, which is provided during an interval between two successive ones of the driving voltage pulses which are output to the dot formation element. Moreover, on the basis of the obtained voltage value, and the temperature characteristic having been preliminarily provided, the temperature measurement control unit can detect a temperature of the transistor at a point during an interval between two successive operations of driving the dot formation element. During a period when any of the driving voltage pulses is output to the dot formation element, the transistor generates the largest amount of heat. Further, according to the aspect of the invention, it is possible to measure the temperature of the transistor during an interval between two successive operations of driving the dot formation element. Therefore, according to the aspect of the invention, it is possible to finely determine whether an operation of cooling the amplification circuit including the transistor, or the like, is to be performed, or not. Moreover, according to the aspect of the invention, it is possible to reduce the number of parts because it is unnecessary to mount additional parts for the temperature measurement, such as a thermistor.

In the aspect of the invention, each of the at least one temperature measurement voltage portion may be provided between one of at least one largest driving voltage pulse of the driving voltage pulses, and one of the driving voltage pulses, which follows the one of at least one largest driving voltage pulse, the at least one largest driving voltage being one having a peak voltage whose absolute value is the largest one of the peak voltages of the driving voltage pulses.

The amount of heat generated by the transistor during a period when a signal (an electric current) corresponding to each of the at least one largest driving voltage pulse (i.e., a driving voltage pulse which has a peak voltage whose absolute value is larger than that of the peak voltage of any other driving voltage pulse) is amplified is larger than the amount of heat generated by the transistor during a period when a signal (an electric current) corresponding to one of the driving voltage pulses, which does not have the peak voltage whose absolute value is the largest one (i.e., a driving voltage pulse which has a peak voltage whose absolute value is smaller than that of the largest driving voltage pulse) is amplified. Therefore, it is possible to, by measuring a temperature of the transistor immediately after each of the at least one largest driving voltage pulse, measure a temperature of the transistor, which is close to a temperature of the transistor at a point during a period when the transistor is likely to generate the largest amount of heat. In addition, each of the at least one largest driving voltage pulse may be a driving voltage pulse having the largest peak-voltage absolute value of driving voltage pulses which are output during a period when dots corresponding to each recording pixel are formed. Assuming a case where just one driving voltage pulse is output during the foregoing period, each of the at least one temperature measurement voltage portion may be provided between the one driving voltage pulse and a driving voltage pulse which is output first during the following period. Further, assuming a case where a plurality of driving voltage pulses is output during the foregoing period, and the largest driving voltage pulse corresponds to the last one of the plurality of driving voltage pulses, each of the at least one temperature measurement portion may be provided between the largest driving voltage pulse which corresponds to the last one of the plurality of driving voltage pulses and a driving voltage pulse which is output first during the following period.

Further, in the aspect of the invention, the voltage signal may become a ground potential after a preceding one of the two successive ones of the driving voltage pulses and before the each of the at least one temperature measurement voltage portion.

In this case, it is possible to measure the temperature of the transistor after a vibration of the voltage signal, which occurs immediately after each of the driving voltage pulses, has been sufficiently attenuated during a period when the voltage signal becomes a ground potential, and thus, it is possible to increase accuracy of the temperature measurement.

Further, in the aspect of the invention, the temperature measurement control unit may measure a temperature of the transistor on the basis of a voltage value which corresponds to each of the at least one temperature measurement voltage portion, and which is obtained after an elapse of a predetermined period of time from a start of amplification performed by the transistor on a signal corresponding to the each of the at least one temperature measurement voltage portion.

In order to sufficiently attenuate a vibration of the voltage signal, which occurs immediately after each of the driving voltage pulses, the measurement of temperature of the transistor is performed after an elapse of a predetermined period of time; whereby it is possible to increase accuracy of the temperature measurement. Therefore, the predetermined period of time is set on the basis of a period of time necessary to attenuate and stabilize the vibration of the voltage signal.

Further, in the aspect of the invention, each of the driving voltage pulses may be a trapezoidal wave including a voltage rising portion, a constant voltage portion and a voltage falling portion, and in this case, each of the at least one temperature measurement voltage portion may be provided between one of at least one steep voltage pulse of the driving voltage pulses, and one of the driving voltage pulses, which follows the one of at least one steep voltage pulse, the at least one steep voltage pulse being one including a first voltage portion which corresponds to the voltage rising portion following the constant voltage portion forming a peak voltage or a second voltage portion which corresponds to the voltage falling portion following the constant voltage portion forming a peak voltage, whichever has the largest gradient of the first voltage portions and the second voltage portions of the driving voltage pulses.

For example, assuming a case where a plurality of driving pulses having the same peak voltage value is output during a period when dots corresponding to each recording pixel are formed, a configuration, in which each of the at least one temperature management voltage portion is provided immediately after one of at least one steep voltage pulse having a voltage falling portion which has the largest gradient of those of the plurality of driving voltage pulses, enables measurement of a temperature of the transistor within a shorter period starting from the output of a peak voltage, as compared with a configuration in which each of the at least one temperature management voltage portion is provided immediately after a driving voltage pulse having a voltage falling portion whose gradient is smaller than that of the voltage falling portion of the steep voltage pulse. Therefore, it is possible to measure a temperature of the transistor, which is closer to a temperature of the transistor at a point during a period when a peak voltage is output.

### BRIEF DESCRIPTION OF THE DRAWINGS

The invention will be described with reference to the accompanying drawings, wherein like numbers reference like elements.

FIG. 1 is a block diagram illustrating an image formation apparatus according to an embodiment of the invention.

FIGS. 2A and 2B are diagrams each illustrating a voltage signal according to a first embodiment of the invention.

FIGS. 3A and 3B are diagrams each illustrating a voltage signal according to other embodiments of the invention.

FIG. 4 is a diagram illustrating a voltage signal according to other embodiments of the invention.

### DESCRIPTION OF EXEMPLARY EMBODIMENTS

Hereinafter, embodiments of the invention will be described with reference to the accompanying drawings. In addition, in the figures, corresponding components are denoted by the same reference numerals, and repeated descriptions thereof will be omitted.

### 1. First Embodiment

### 1-1. Configuration

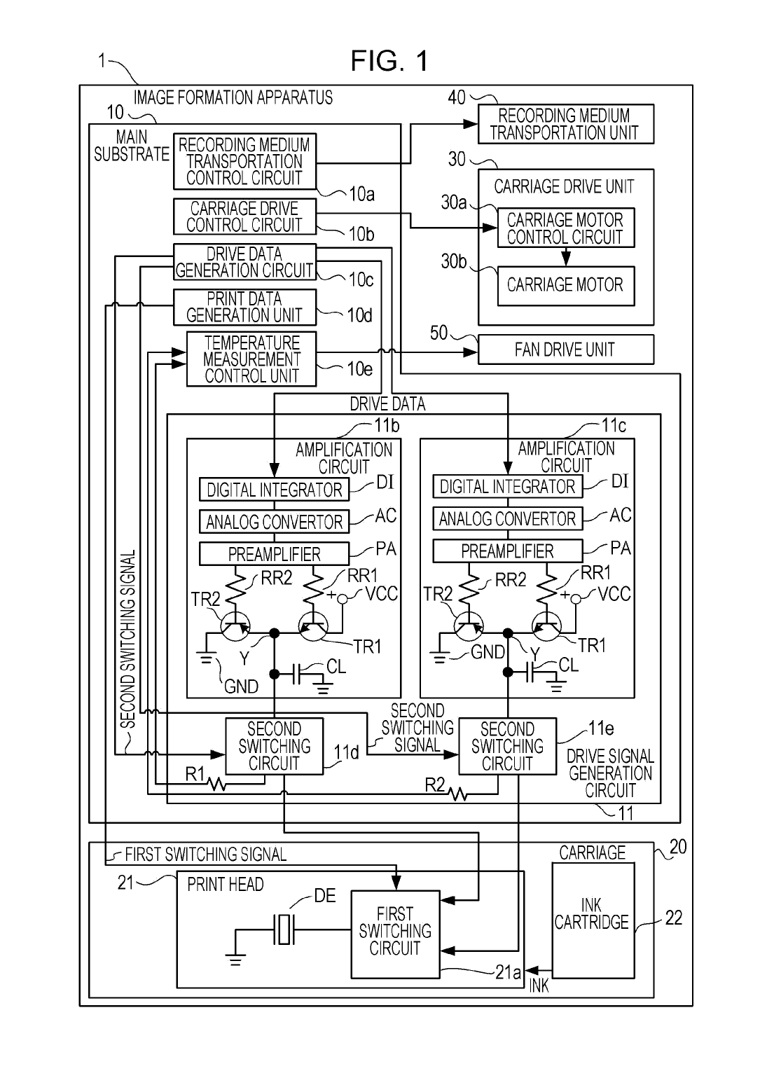

FIG. 1 is a block diagram illustrating an image formation apparatus 1 according to an embodiment of the invention. The image formation apparatus 1 is a serial ink jet printer which forms print images on a recording medium by reciprocating a print head thereof in the main scanning direction. The image formation apparatus 1 includes a main substrate 10, a carriage 20, a carriage drive unit 30, a recording medium transportation unit 40 and a fan drive unit 50. The main substrate 10 is a substrate on which a CPU, ROM modules, RAM modules, ASICs and the like are mounted, and includes a recording medium transportation control circuit 10a, a carriage drive control circuit 10b, a drive data generation circuit 10c, a print data generation section 10d, a temperature measurement control unit 10e and a drive signal generation circuit 11. The drive data generation circuit 10c and the drive signal generation circuit 11 correspond to a voltage signal generation circuit.

The carriage 20 includes a print head 21 and an ink cartridge 22. The carriage 20 moves in the main scanning direction. The print head 21 includes a plurality of dot formation elements DE, and a first switching circuit 21a for each of the dot formation elements DE. The dot formation element DE includes a piezoelectric element which has a piezoelectric material interposed between a pair of electrodes, a vibration plate which vibrates by being driven by the piezoelectric element, an ink chamber which has the vibration plate as a wall thereof, and a nozzle which is communicated with the ink chamber. Applying driving voltage pulses, each functioning as a drive signal, to the piezoelectric element of the dot formation element DE causes increases and reductions of the pressure of ink filled in the ink chamber; thereby causing ink drops to be discharged through the nozzle communicated with the ink chamber, and be struck onto a recording medium, so that dots are formed on the recording medium. Moreover, the ink is supplied to the ink chamber from the ink cartridge 22 included in the carriage 20. The first switching circuit 21a receives two kinds of signals described below having been amplified by corresponding amplification circuits 11b and 11c, and performs switching in accordance with a first switching signal to select one of the two kinds of signals to be input to the dot formation element, so that driving voltage pulses, which are included in the selected one of the two kinds of signals, are applied to the dot formation element DE.

The drive signal generation circuit 11 is a circuit configured to generate two kinds of signals, each kind thereof having a voltage waveform which includes the driving voltage pulses to be applied to the dot formation element DE, as well as temperature measurement voltage portions. Further, the drive signal generation circuit 11 generates the two kinds of signals on the basis of corresponding two kinds of drive data having been input from the drive data generation circuit 10c. The drive data generation circuit 10c outputs the two kinds of drive data, which enable generation of the corresponding two kinds of signals appropriate to mutually different print conditions and the like, to the drive signal generation circuit 11. Further, the drive data generation circuit 10c outputs two kinds of second switching signals, each kind thereof enabling switching of the output destination of a corresponding one of the two kinds of signals generated by the drive signal generation circuit 11, to corresponding second switching circuits 11d and 11e included in the drive signal generation circuit 11. The print data generation unit 10d generates print data by sequentially executing resolution conversion processing, color conversion processing, halftone processing, rearrangement processing and the like on the basis of image data targeted for printing, and outputs the first switching signal corresponding to the generated print data to the first switching circuit 21a so as to cause the first switching circuit 21a to, in accordance with the generated print data, switch the driving voltage pulses to be applied to the dot formation element DE.

The drive signal generation circuit 11 includes the two amplification circuits 11b and 11c and the two second switching circuits 11d and 11e (each corresponding to a switch circuit described in the appended claim). The amplification circuits 11b and 11c have the same circuit configuration, in which a digital integrator DI, an analog convertor AC, a preamplifier PA, resistors RR1 and RR2, amplification transistors TR1 and TR2, and a smoothing capacitor CL are provided. The amplification circuits 11b and 11c generate the two kinds of signals on the basis of the two kinds of drive data having been input thereto, respectively. Further, the two kinds of signals include corresponding two kinds of driving voltage pulses, and waveforms of the corresponding two kinds of driving voltage pulses are different from each other (in addition, generation timings of two kinds of temperature measurement voltage portions included in the corresponding two kinds of signals are likely to be different from each other).

The digital integrator DI generates data indicating integrated values resulting from integrating the drive data having been input from the drive data generation circuit 10c at intervals of a predetermined very small period of time, and sequentially outputs the generated data to the analog convertor AC. The analog convertor AC converts the data indicating integrated values into electric current pulses, and outputs the electric current pulses to the preamplifier PA. The preamplifier PA generates positive electric current pulses resulting from extracting electric current elements each having an electric current value larger than a predetermined electric current value, as well as negative electric current pulses resulting from extracting electric current elements each having an electric current value smaller than or equal to the predetermined electric current value. Further, the preamplifier PA outputs the positive electric current pulses and the negative current pulses to the base electrode of the amplification 1 and the base electrode of the amplification transistor 2 via a resistor RR1 and a resistor RR2, respectively. The amplification transistor TR1 is an NPN type bipolar transistor, and the collector electrode thereof is connected to a direct-current power supply VCC. Meanwhile, the amplification transistor TR2 is a PNP type bipolar transistor, and the collector electrode thereof is connected to a ground GND. The emitter electrodes of the amplification transistors TR1 and TR2 are connected to each other at an output point Y, and from this output point Y, signals corresponding to the driving voltage pulses are output to the dot formation element DE via the second switching circuit 11d (or the second switching circuit 11e) and the first switching circuit 21a.

Here, when the positive electric current pulse supplies the base electrode of the amplification transistor TR1 with a positive electric current, an amount of resistance between the collector electrode and the emitter electrode of the amplification transistor TR1 is reduced, so that the voltage of the emitter electrode thereof is pulled up by the direct-current power supply VCC. Meanwhile, when the negative electric current pulse supplies the base electrode of the amplification transistor TR2 with a negative electric current, an amount of resistance between the collector electrode and the emitter electrode of the amplification transistor TR2 is reduced, so that the voltage of the emitter electrode thereof is pulled down by the ground GND. In addition, an electric current flowing between the collector electrode and the emitter electrode of a transistor causes the transistor to generate a certain amount heat. As described above, each of the amplification circuits 11b and 11c constitutes a so-called push-pull amplification circuit to output an amplified electric current from the output point Y. In addition, the positive electric current pulse and the negative electric current pulse alternatively cause a conductive condition between the collector electrode and the emitter electrode of the amplification transistor TR1, and a conductive condition between the collector electrode and the emitter electrode of the amplification transistor TR2, respectively, and while one of the conductive conditions occurs, the other one thereof does not occur. The output point Y of the amplification circuit 11b and the output point Y of the amplification circuit 11c are connected to the second switching circuit 11d and the second switching circuit 11e, respectively. Further, the smoothing capacitor CL smoothens an electric current flowing to the dot formation element DE.

The second switching circuit 11d switches the output destination of an input signal having been input thereto to the dot formation element DE or the temperature measurement control unit 10e in accordance with the second switching signal having been output from the drive data generation circuit 10c. Similarly, the second switching circuit 11e switches the out destination of an input signal having been input thereto to the dot formation element DE or the temperature measurement control unit 10e in accordance with the second switching signal having been output from the drive data generation circuit 10c. The second switching circuit 11d is connected to the temperature measurement control unit 10e via a resistor R1. The second switching circuit 11e is connected to the temperature measurement control unit 10e via a resistor R2. The temperature measurement control unit 10e includes A/D convertors (not illustrated) configured to convert voltage values, which reflect voltages obtained by causing signals (electric currents) having been input from the second switching circuits 11d and 11e to flow through the resistors R1 and R2, into digital values, respectively, and measures the temperatures of the amplification transistors TR1 and TR2 on the basis of the corresponding digital values.

The recording medium transportation unit 40 includes a transportation motor control circuit, a transportation motor, and a transportation roller (which are not illustrated). The recording medium transportation unit 40 transports a recording medium in the direction orthogonal to the main scanning direction by causing the transportation motor control unit to drive the transportation motor on the basis of transportation control data having been input from the recording medium transportation control circuit 10a mounted on the main substrate 10.

The carriage drive unit 30 includes a carriage motor control circuit 30a and a carriage motor 30b. The carriage motor control circuit 30a generates drive signals for driving the carriage motor 30b on the basis of movement control data having been input from the carriage drive control circuit 10b. The drive signals drive the carriage motor 30b, so that the carriage 20 is caused to move in the main scanning direction.

The fan drive unit 50 is configured to include a fan for sending air to the amplification circuits 11b and 11c, a motor for driving the fan, a motor control circuit and the like. The fan drive unit 50 drives and halts the fan in accordance with control signals having been input from the temperature measurement control unit 10e.

### 1-2. Driving Operation on Dot Formation Element and Temperature Measurement

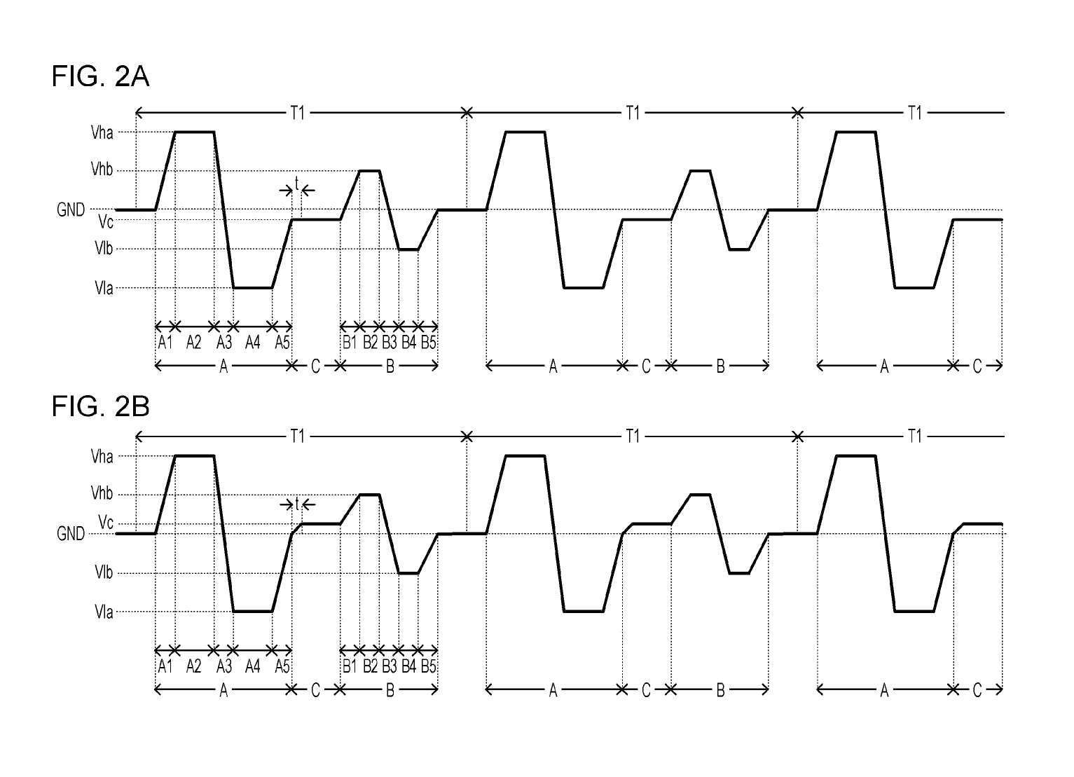

FIG. 2A is a diagram illustrating a waveform of a voltage signal which is applied to the dot formation element DE in the case where an electric current having been input to the second switching circuit 11d from the amplification circuit 11b is input to the dot formation element DE as it is without being switched to another output destination of the electric current. Since a proportional relation exists between an electric current input to the dot formation element DE and a voltage applied to the dot formation element DE, a waveform of the electric current input to the dot formation element DE is similar to that shown in FIG. 2A. In FIG. 2A, it is shown that a driving voltage pulse A and a driving voltage pulse B are provided during a cycle T1 which corresponds to a cycle of processing performed on each recording pixel. The driving voltage pulse A is a trapezoidal wave composed of a voltage rising portion A1, a constant voltage portion A2, a voltage falling portion A3, a constant voltage portion A4, and a voltage rising portion A5. Similarly, the driving voltage pulse B is a trapezoidal wave composed of a voltage rising portion B1, a constant voltage portion B2, a voltage falling portion B3, a constant voltage portion B4, and a voltage rising portion B5. The absolute values of peak voltages Vhb and V1b (i.e., the voltages of the constant voltage portions) of the driving voltage pulse B are smaller than those of peak voltages Vha and V1a of the driving voltage pulse A, respectively. Therefore, the driving voltage pulse A corresponds to a largest driving voltage pulse within the cycle T1. In this embodiment, a temperature measurement voltage portion C is provided after the driving voltage pulse A and before the driving voltage pulse B. The temperature measurement voltage portion C is composed of one constant voltage portion having an arbitrary constant voltage value. The temperature measurement voltage portion C is composed of one constant voltage portion having, for example, a voltage Vc whose absolute value Vc is small enough not to make an effect on an amount of ink drops discharged during the cycle T1 (but Vc≠GND) even if the temperature measurement voltage portion C is applied to the dot formation element DE without being output to the temperature measurement control unit 10e (in the case where the temperature measurement is not performed). Further, the length of the temperature measurement voltage portion C is sufficient if the length thereof is shorter than the length of a period from the end point of the driving voltage pulse A to the start point of the driving voltage pulse B, and further, is long enough to enable the temperature measurement control unit 10e to perform the temperature measurement. The drive data generation circuit 10c outputs drive data, which enables generation of a signal corresponding to the voltage signal having the waveform shown in FIG. 2A, to the amplification circuit 11b, and the amplification circuit 11b repeatedly generates the signal corresponding to the drive data at intervals of the cycle T1. The amplification circuit 11c also obtains drive data, which enables generation of a signal corresponding to a voltage signal having a waveform different from that shown in FIG. 2A, from the drive data generation circuit 10c, and repeatedly generates the signal corresponding to the drive data at intervals of the cycle T1.

The drive data, which enables generation of the temperature measurement voltage portion C, is preliminarily determined. Therefore, in the configuration according to this embodiment, it can be also specified at a circuit design stage whether the polarity of an electric current pulse, which is output by the preamplifier PA when the drive data that enables generation of the temperature measurement voltage portion C has been input to the amplification circuit 11b or the amplification circuit 11c, is to be positive or negative. For example, in the case where the electric current pulse, which is output from the preamplifier PA on the basis of the drive data that enables generation of the temperature measurement voltage portion C, is a negative electric current pulse, the amplification transistor TR2 operates. A correspondence relation between temperatures, and voltage values that are obtained by the temperature measurement control unit 10e in the case where the drive data that enables generation of the temperature measurement voltage portion C is input to the amplification circuit 11b under a plurality of temperature conditions, is preliminarily obtained. Further, information indicating the correspondence relation is preliminarily recorded in ROM modules or the like accessible from the temperature measurement control unit 10e. Similarly, regarding a temperature measurement voltage portion (not illustrated) included in the signal generated by the amplification circuit 11c, a correspondence relation between temperatures, and voltage values that are obtained by the temperature measurement control unit 10e in the case where drive data that enables generation of the temperature measurement voltage portion is input to the amplification circuit 11c under a plurality of temperature conditions, is also preliminarily obtained. In general, under the condition where an amount of base electric current of a transistor is constant, higher temperature of the transistor results in an increase of an amount of electric current flowing between the collector electrode and the emitter electrode of the transistor, and thus, the absolute value of a voltage value corresponding to the electric current becomes larger. In addition, the temperatures to be measured at this preparation stage are obtained by means of, for example, a method of measuring temperatures of the transistors TR1 and TR2 themselves by using a different apparatus for the temperature measurement.

During a period when the amplification circuit 11b amplifies a signal corresponding to the temperature measurement voltage portion C, the drive data generation circuit 10c outputs a signal (i.e., the second switching signal), which causes the signal corresponding to the temperature measurement voltage portion C to be output to the temperature measurement control unit 10e, to the second switching circuit 11d. Further, during a period when the amplification circuit 11b amplifies a signal corresponding to a portion other than the temperature measurement voltage portion C, the drive data generation circuit 10c outputs a signal (i.e., the second switching signal), which causes the signal corresponding to the portion other than the temperature measurement voltage portion C to be output to the dot formation element DE, to the second switching circuit 11d. Therefore, the driving voltage pulses A and B are output to the dot formation element DE, and the temperature measurement voltage portion C is output to the temperature measurement control unit 10e. The driving voltage pulses A and B are applied to the dot formation element DE, thereby enabling the ink drops to be discharged through the nozzle. Similarly, regarding the second switching circuit 11e, the output destinations of a signal corresponding to the temperature measurement voltage portion and a signal corresponding to a portion other than the temperature measurement voltage portion are switched in accordance with the second switching signal.

The temperature measurement control unit 10e obtains a voltage value of a signal corresponding to the temperature measurement voltage portion C in the form of a digital value by performing A/D conversion of a voltage signal of the signal corresponding to the temperature measurement voltage portion C, the voltage signal being included within a predetermined sampling period of time (for example, 1 μsec) starting from a point at which a predetermined period of time t has elapsed since the start of a period when the signal corresponding to the temperature measurement voltage portion C is amplified. That is, the temperature measurement control unit 10e obtains a voltage signal of a stable portion of a signal corresponding to the temperature measurement voltage portion C, the stable portion thereof being a portion which is captured after an elapse of a predetermined period of time t from the start of a period when the signal corresponding to the temperature measurement voltage portion C is amplified. Therefore, it is possible to handle a stable voltage value as a target for the temperature measurement by sufficiently attenuating a vibration of the signal corresponding to the temperature measurement voltage portion C, which occurs immediately after the voltage rising portion AS of the driving voltage pulse A.

In the example shown in FIG. 2A, since a signal that makes the polarity of the electric potential of the temperature measurement voltage portion C negative is generated, the temperature measurement control unit 10e can obtain the voltage value Vc corresponding to the temperature measurement voltage portion C which has been generated by the amplification transistor TR2 of the amplification circuit 11b. Further, on the basis of the voltage value Vc and the above-described information indicating the correspondence relation, the temperature measurement control unit 10e can detect a temperature of the amplification transistor TR2 included in the amplification circuit 11b at a point during a period when the temperature measurement portion C is generated. Similarly, the temperature measurement control unit 10e can also detect a temperature of the transistor TR2 of the amplification circuit 11c. If the detected temperature is higher than a predetermined reference value, the temperature measurement control unit 10e transmits a control signal for driving the fan to the fan drive unit 50. Further, if the detected temperature is lower than a predetermined reference value, the temperature measurement control unit 10e transmits a control signal for halting the fan to the fan drive unit 50.

During a period when amplifying an electric current corresponding to a peak voltage of each of the driving voltage pulses, the transistor generates the largest amount of heat. Further, according to this embodiment, it is possible to measure the temperature of the transistor by using intervals each being provided between two successive operations of driving the dot formation element DE. Therefore, it is possible to finely determine whether an operation of cooling the amplification circuit including the transistor, or the like, is to be performed, or not. Further, according to this embodiment, it is possible to reduce cost because it is unnecessary to mount additional parts for the temperature measurement. Moreover, according to this embodiment, the temperature measurement voltage portion C is provided between the driving voltage pulse A, which is the largest driving voltage pulse, and the driving voltage pulse B, which follows the driving voltage pulse A. The temperature of the transistor TR1 during a period when the driving voltage pulse A is generated is higher than that of the transistor TR1 during a period when the driving voltage pulse B is generated because the amount of heat generated by the transistor TR1 during a period when the driving voltage pulse A is generated is larger than that generated by the transistor TR1 during a period when the driving voltage pulse B is generated (because the peak voltage of the driving voltage pulse A is larger than that of the driving voltage pulse B). Thus, it is possible to, by measuring a temperature of the amplification transistor TR1 immediately after the driving voltage pulse A, measure a temperature thereof close to a temperature thereof at a point during a period when the amplification transistor TR1 generates the largest amount of heat.

FIG. 2B is a diagram which illustrates a voltage signal that is applied to the dot formation element DE when an electric current having been input to the second switching circuit 11d from the amplification circuit 11b is input to the dot formation element DE as it is without being switched to another output destination of the electric current, and which illustrates a case where a signal corresponding to the temperature measurement voltage portion C is amplified by the amplification transistor TR1. As described in the example shown in FIG. 2A, it is possible to measure the temperature of the amplification transistor TR2, and it is also possible to measure the temperature of the amplification transistor TR1 in a way similar to that described above regarding the amplification transistor TR2. That is, it is possible to measure the temperature of the amplification transistor TR1 by creating drive data that enables generation of the temperature measurement voltage portion C so as to cause the preamplifier PA to output a positive electric current, and preliminarily obtaining a correspondence relation between voltage values, which are obtained by the temperature measurement control unit 10e, and temperatures.

### 2. Other Embodiments

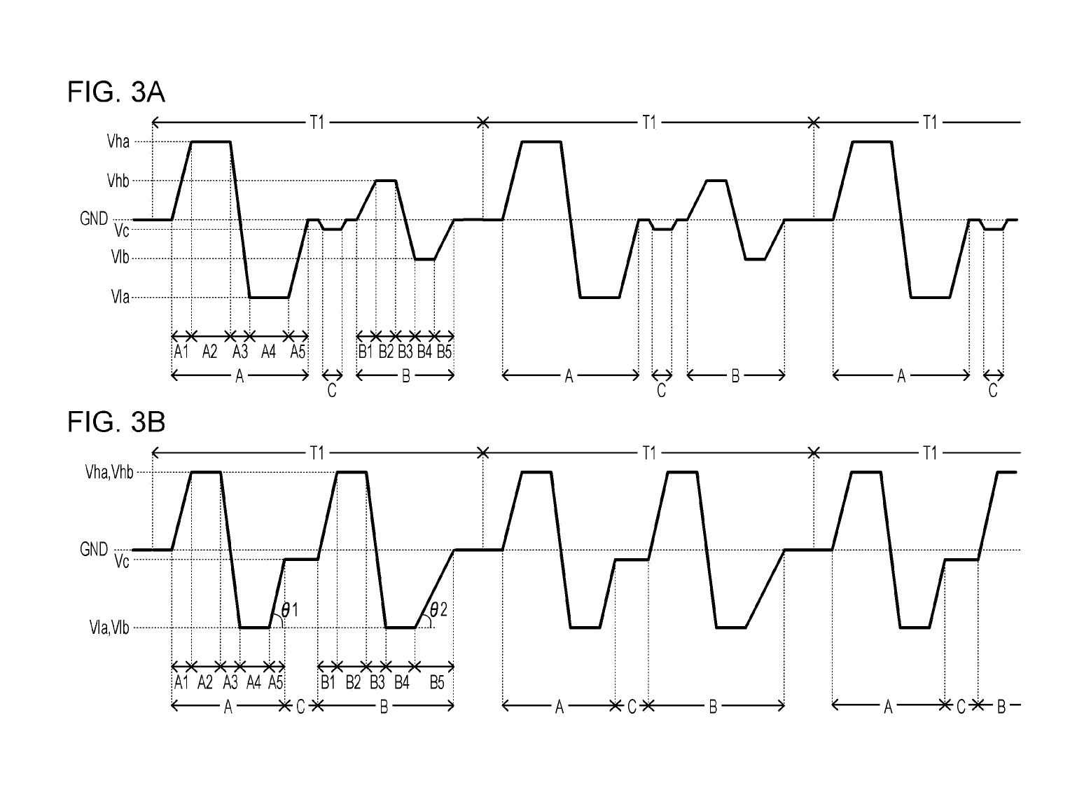

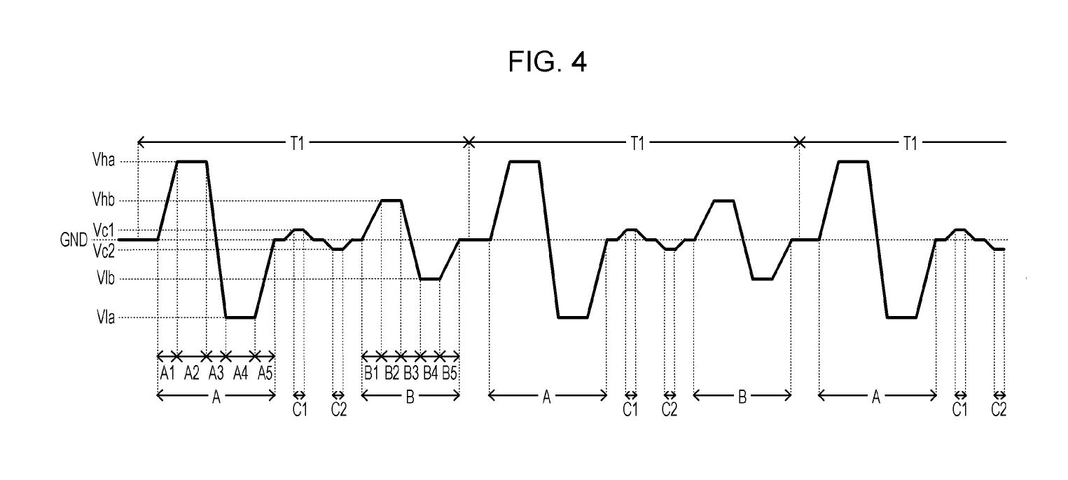

In addition, naturally, the scope of the invention is not limited to the embodiment described above, but various modifications can be made thereto within the scope not departing from the gist of the invention. FIGS. 3A, 3B and 4 are diagrams each illustrating a voltage signal, which is applied to the dot formation element DE when an electric current having been input to the second switching circuit 11d (or 11e) from the amplification circuit 11b (or 11c) is input to the dot formation element DE as it is without being switched to another output destination of the electric current. For example, as shown in FIG. 3A, the voltage signal may be maintained at a ground potential during a certain predetermined period immediately before the start of the temperature measurement voltage portion C. In this way, it is possible to stabilize a signal corresponding to the temperature measurement voltage portion C by attenuating a vibration of the signal, which is caused by the voltage rising portion A5 that is output immediately before the temperature measurement voltage portion C, and thus, it is possible to increase accuracy of the temperature measurement. In addition, since the temperature measurement voltage portion C does not need a large amount of electric current, the vibration of the signal does not occur during a period when the signal moves from the ground potential to the temperature measurement voltage portion C.

Further, as shown in FIG. 3B, the temperature measurement voltage portion C may be provided between a steep voltage pulse (the driving voltage pulse A), which is a driving voltage pulse having a voltage rising portion whose gradient is the largest one, and the driving voltage pulse B, which follows the steep voltage pulse. FIG. 3B shows that, regarding the driving voltage pulses A and B, the peak voltages Vha and Vhb have the same voltage value, as well as the peak voltages V1a and V1b, and a gradient θ1 of the voltage rising portion A5, which follows the constant voltage portion A4 forming one of two peak voltages of the driving voltage pulse A, is larger (steeper) than a gradient θ2 of the voltage rising portion B5, which follows the constant voltage portion B4 forming one of two peak voltages of the driving voltage pulse B. In the case where the temperature measurement voltage portion C is provided immediately after the driving voltage pulse A (the steep voltage pulse) having the voltage rising portion A5 which follows the constant voltage portion A4 forming a peak voltage, and which has the largest gradient, it is possible to measure the temperature of the transistor within a shorter period of time starting from a point at which the peak voltage has been output, as compared with the case where the temperature measurement voltage portion C is provided immediately after the driving voltage pulse B having the voltage rising portion B5 which has a smaller gradient than the voltage rising portion A5 of the steep driving voltage pulse A. Therefore, it is possible to measure a temperature of the transistor, which is closer to a temperature of the transistor at a point during a period when a peak voltage is output.

Further, in the above-described embodiment, an example, in which one temperature measurement voltage portion is provided within the cycle T1 which corresponds to a cycle of processing performed on each recording pixel, has been described, and if, within the cycle T1, there exists any period of time which is not overlapped by any driving voltage pulse, and which has a sufficient length, a plurality of temperature measurement voltage portions may be provided within the cycle T1. For example, in each of FIGS. 2A, 2B, 3A and 3B, the temperature measurement portion C may be also provided after the driving voltage pulse B and before the driving voltage pulse A of the following cycle T1.

Moreover, as shown in FIG. 4, a temperature measurement voltage portion C1 that enables measurement of the temperature of the amplification transistor TR1 (which causes the preamplifier PA to output a positive electric current) and a temperature measurement voltage portion C2 that enables measurement of the temperature of the amplification transistor TR2 (which causes the preamplifier PA to output a negative electric current) may be provided between the driving voltage pulse A and the driving voltage pulse B. Furthermore, the temperature measurement voltage portions C1 and C2 may be provided such that one of the temperature measurement voltage portions C1 and C2 is located after the driving voltage pulse A and before the driving voltage pulse B, and the other one thereof is provided after the driving voltage pulse B and before the driving voltage pulse A of the following cycle T1.

In addition, the waveform of the driving voltage pulse is not limited to that in the example of the above-described embodiment. The waveform of the driving voltage pulse may be more complicated than the trapezoidal waveform shown in the above-described embodiment. Further, the waveform of the driving voltage pulse may not be the trapezoidal wave, but may be, for example, a rectangular wave.

What is claimed is:

1. An image formation apparatus comprising:
a dot formation element;
a voltage signal generation circuit configured to generate a voltage signal by using an amplification circuit including a transistor, the voltage signal including a plurality of driving voltage pulses each thereof driving the dot formation element, and at least one temperature measurement voltage portion each thereof being provided between two successive ones of the driving voltage pulses;
a temperature measurement control unit configured to measure a temperature of the transistor on the basis of the voltage signal; and
a switch circuit configured to output the voltage signal to the dot formation element during a period when the transistor amplifies a signal corresponding to each of the driving voltage pulses, and output the voltage signal to the temperature measurement control unit during a period when the transistor amplifies a signal corresponding to each of the at least one temperature measurement voltage portion.

2. The image formation apparatus according to claim 1, wherein each of the at least one temperature measurement voltage portion is provided between one of at least one largest driving voltage pulse of the driving voltage pulses, and one of the driving voltage pulses, which follows the one of at least one largest driving voltage pulse, the at least one largest driving voltage being one having a peak voltage whose absolute value is the largest one of the peak voltages of the driving voltage pulses.

3. The image formation apparatus according to claim 1, wherein the voltage signal becomes a ground potential after a preceding one of the two successive ones of the driving voltage pulses and before the each of the at least one temperature measurement voltage portion.

4. The image formation apparatus according to claim 1, wherein the temperature measurement control unit measures a temperature of the transistor on the basis of a voltage value which corresponds to each of the at least one temperature measurement voltage portion, and which is obtained after an elapse of a predetermined period of time from a start of amplification performed by the transistor on a signal corresponding to the each of the at least one temperature measurement voltage portion.

5. The image formation apparatus according to claim 1, wherein each of the driving voltage pulses is a trapezoidal wave including a voltage rising portion, a constant voltage portion and a voltage falling portion, and each of the at least one temperature measurement voltage portion is provided between one of at least one steep voltage pulse of the driving voltage pulses, and one of the driving voltage pulses, which follows the one of at least one steep voltage pulse, the at least one steep voltage pulse being one including a first voltage portion which corresponds to the voltage rising portion following the constant voltage portion forming a peak voltage or a second voltage portion which corresponds to the voltage falling portion following the constant voltage portion forming a peak voltage, whichever has the largest gradient of the first voltage portions and the second voltage portions of the driving voltage pulses.
